(19) United States
(12) Patent Application Publication
(10) Pub. No.: US 2005/0172455 A1
(43) Pub. Date: Aug. 11, 2005

(54) Hinge assembly with cammed driving

(75) Inventors: Yong-Jian Chen, Shenzhen (CN); Xing-Bing Zou, Shenzhen (CN)

Correspondence Address: MORRIS MANNING & MARTIN LLP, 1600 ATLANTA FINANCIAL CENTER, 3343 PEACHTREE ROAD, NE, ATLANTA, GA, 30326-1044, US

(73) Assignee: HON HAI Precision Industry CO., LTD., Tu-Cheng City (TW)

(21) Appl. No.: 10/951,512

(22) Filed: Sep. 28, 2004

(30) Foreign Application Priority Data
Feb. 6, 2004 (TW) 93201653

(51) Int. Cl. E05D 11/08

(52) U.S. Cl. 16/330

(57) ABSTRACT

A hinge assembly for joining a cover to a main body of a foldable device includes a hollow housing (10), a spring (20), a shaft (30), and a positioning pin (40). The housing includes an open end, an opposite rear end (11). The spring is received in the housing. The shaft includes a cam portion (34) received in the housing, and a shaft portion (32) passing through the spring and extending out through the rear end. One end of the spring biases the cam portion, and an opposite end of the spring biases the rear end. The pin is transversely retained in the housing near the open end, and is rotatable relative to the shaft and movably engaged with a cam surface of the cam portion. When the rear end is urged in an axial direction by the spring, the cam surface causes the pin to rotate the housing.

### CROSS-REFERENCE TO RELATED APPLICATIONS

This application is related to a copending U.S. patent application entitled “HINGE ASSEMBLY WITH UNIVERSALLY BIASED CAM”, filed on the same date with the same applicant and assignee as the invention. The disclosure of the above identified applications is incorporated herein by reference.

### BACKGROUND OF THE INVENTION

1. Field of the Invention

The present invention generally relates to an apparatus for hinging together the housings of a foldable, portable communication device such as a handheld radiotelephone, and in particular to an apparatus which facilitates opening and closing of the device.

2. Prior Art

Portable radiotelephones generally have two housings joined by a type of hinge that allows the housings to fold upon one another. Many such foldable radiotelephones have most of the electronics in one housing, called the main housing, and fewer electronics in the other housing, called the cover. Other such foldable radiotelephones have all the electronics in the main housing, with the cover serving only to cover a keypad and a display of the main housing. Manufacturers are constantly seeking to reduce the volume, size and weight of portable radiotelephones. Thus, it is desirable that the hinge coupling the main housing with the cover is modularized and miniaturized. A modularized hinge device has moving parts such as a cam member, a cam follower and a spring held together in a unified structure. The structure is easily and quickly attached to the main housing and the cover during mass production. A miniaturized hinge device has as few parts as possible, with the parts being as small as practicable.

One kind of portable cellular radiotelephone with a hinge mechanism is shown in FIG. 5. The hinge mechanism comprises a spring 54 and a hinge pins 50, 52 disposed in a tubular hinge arm 642 formed at an end of a cover 64, and a bushing 66 formed in a body 62. The spring 54 is positioned between the hinge pins 50, 52, and constantly forces the hinge pins 50, 52 in opposite directions such that the hinge pins 50, 52 are rotatably engaged with the bushings 66.

Although suitable for some foldable radiotelephones, the above-described hinge mechanism is not suitable for certain miniaturized foldable radiotelephones. This is because the housing of a miniaturized radiotelephone may not have sufficient bulk to sturdily withstand the forces generated from the spring. In addition, because the hinge mechanism is not modularized, it is unsuited for efficient mass production. Furthermore, the small housing makes it particularly difficult to assemble the hinge mechanism.

Therefore, a new hinge assembly is desired in order to overcome the above-described problems.

### SUMMARY OF THE INVENTION

Accordingly, an object of the present invention is to provide a hinge assembly for attaching the housings of a foldable device together; and in particular, a hinge assembly that has a relatively simple and small modularized configuration.

To achieve the above-mentioned object, a hinge assembly of the present invention is for joining a cover to a main body of a foldable electronic device. The hinge assembly comprises a hollow housing, an urging mechanism, a shaft, and a positioning pin. The housing comprises an open end, a hole in an opposite rear end, and a pair of opposite pinholes defined in a peripheral wall of the housing adjacent to the open end. The urging mechanism is received in the housing. The shaft comprises a cam portion received in the housing, and a shaft portion passing through the urging mechanism and extending out through the hole of the housing. One end of the urging mechanism biases the cam portion, and an opposite end of the urging mechanism biases the rear end. The positioning pin is retained in the pinholes of the housing, and is rotatable relative to the shaft and movably engaged with a cam surface of the cam portion. When the rear end is urged in an axial direction by the urging mechanism, the cam surface causes the positioning pin to rotate the housing. Conversely, when the positioning pin is rotated by an external force, the housing is driven in an opposite axial direction and compresses the urging mechanism.

Other objects, advantages and novel features of the invention will become more apparent from the following detailed description when taken in conjunction with the accompanying drawings, in which:

### BRIEF DESCRIPTION OF THE DRAWINGS

FIG. 1 is an exploded, isometric view of a hinge assembly in accordance with a preferred embodiment of the present invention;

FIG. 2 is an assembled view of FIG. 1;

FIG. 3 is a cross-sectional view taken along line III-III of FIG. 2, showing the hinge assembly in a first position;

FIG. 4 is similar to FIG. 3, but showing the hinge assembly in a second position; and

FIG. 5 is an exploded, isometric view of a portable cellular radiotelephone with a hinge assembly of the prior art.

### DETAILED DESCRIPTION OF THE INVENTION

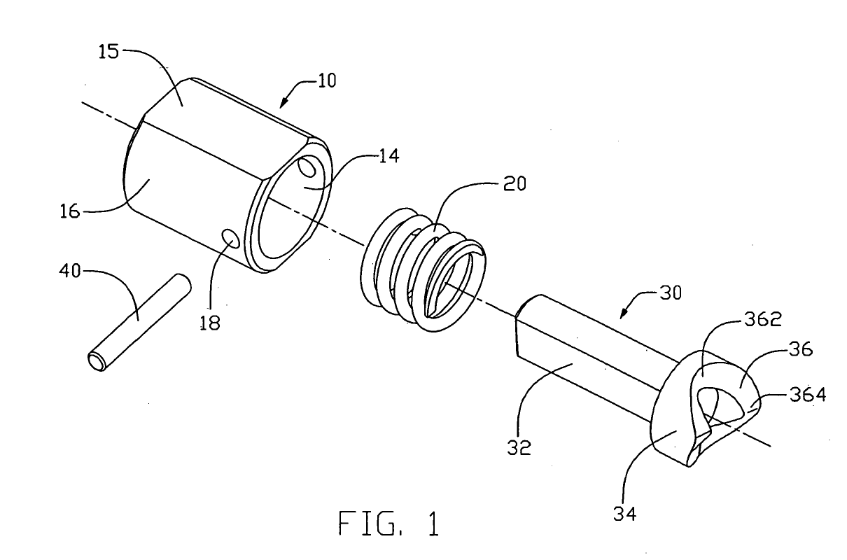

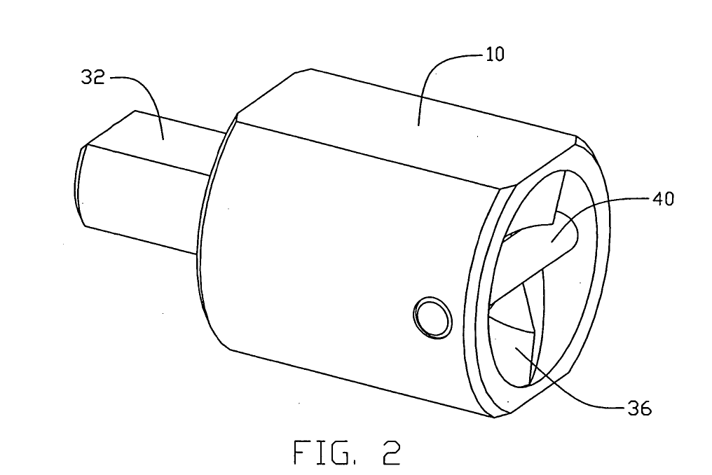

Referring now to the drawings in detail, FIGS. 1 and 2 show a hinge assembly for joining a cover to a main body of a portable electronic device like a foldable mobile radiotelephone (not shown). The hinge assembly comprises a housing 10, a spring 20, a shaft 30, and a positioning pin 40. The spring 20 and a portion of the shaft 30 are received in the housing 10. The positioning pin 40 is inserted into the housing 10 for fixing the hinge assembly together.

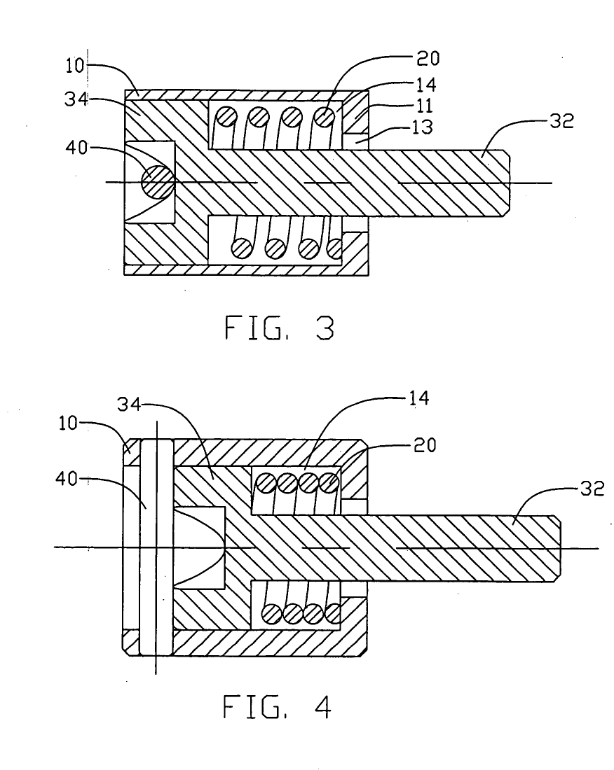

Referring also to FIG. 3, the housing 10 is generally a hollow cylinder. The housing 10 is partly closed off at a rear end and open at a front end thereof, thus forming a rear wall 11 at the rear end and an open end (not labeled) at the front end. The rear wall 11 defines a central hole 13, for the shaft 30 to extend through. The housing 10 defines a cavity 14, and includes a pair of opposite planar sidewalls 15 and a pair of opposite arcuate sidewalls 16. The planar sidewalls 15 enable the housing 10 to be easily fixed in the cover of the radiotelephone. A pair of opposite pinholes 18 is defined through the arcuate sidewalls 16 of the housing 10 adjacent to the open end. The pinholes 18 are aligned with each other.

The spring 20 as an elastic element is metallic and helical, with an outer diameter smaller than an inner diameter of the housing 10.

The shaft 30 includes a shaft portion 32 and a cam portion 34. The shaft portion 32 is a generally cylindrical body with two opposite planar sides. A diameter of the shaft portion 32 is smaller than an inner diameter of the spring 20. The planar sides of the shaft portion 32 enable it to be easily fixed in the main body of the radiotelephone. The cam portion 34 has a cam surface 36 with two valleys 362 and two peaks 364 formed thereon. Preferably, the valleys 362 are pitched 180 degrees from each another, and the peaks 364 are pitched 180 degrees from each other. The cam portion 34 has a diameter smaller than the inner diameter of the housing 10, and larger than the diameter of the shaft portion 32.

The positioning pin 40 as a position member is cylindrical, and has a diameter corresponding to a common diameter of the pinholes 18. In the preferred embodiment, the positioning pin 40 has a diameter slightly greater than the diameter of the pinholes 18, so that the positioning pin 40 can inserted into the housing 10 and interferingly fixed at the opened end thereof.

Referring to FIGS. 1-4, in assembly, the shaft portion 32 is inserted into the spring 20. The combined shaft 30 and spring 20 is inserted into the housing 10 through the open end thereof. The shaft portion 32 of the shaft 30 is extended out of the housing 10 through the hole 13. The shaft 30 is urged to compress the spring 20, so that the cam portion 34 is received in the housing 10. The positioning pin 40 is interferingly fixed in the pinholes 18, with opposite ends of the positioning pin 40 being substantially coplanar with outer surfaces of the arcuate sidewalls 16 of the housing 10. Thus the positioning pin 40 locks the combined shaft 30 and spring 20 in the housing 10. When the urging of the shaft 30 is released, the spring 20 urges the cam portion 34 toward the open end of the housing 10, but the cam portion 34 is blocked by the positioning pin 40 and thus retained in the housing 10. The cam surface 36 of the cam portion 34 always contacts the positioning pin 40 no matter what rotational position the cam portion 34 is in, because of the urging force of the spring 20. Finally, the housing 10 is engaged in a cavity (not shown) of the cover of the radiotelephone, and the exposed end of the shaft portion 32 of the shaft 30 is engaged in the main body of the radiotelephone.

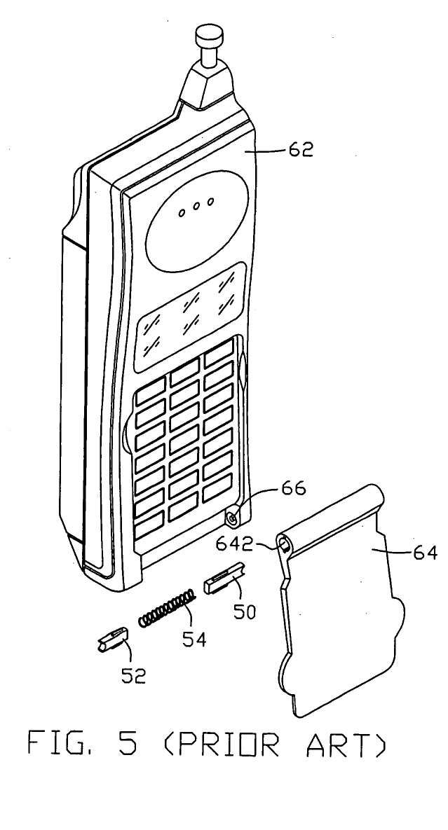

In use, when the cover of the radiotelephone is rotated between an open position and a closed position, or vice versa, the housing 10 rotates along with the cover, while the shaft 30 remains fixed in the main body of the radiotelephone. The positioning pin 40 rotates along with the housing 10. As a result, the positioning pin 40 rides along the cam surface 36 from the valleys 362 to the peaks 364 (see FIG. 4), with the housing 10 moving away from the main body and the spring 20 being compressed. Once the positioning pin 40 passes over the peaks 364, the spring 20 decompresses and drives the housing 10 back toward the main body. The positioning pin 40 thus rides along the cam surface 36 from the peaks 364 to the valleys 362. Accordingly, the cover is moved 180 degrees relative to the main body, with the positioning pin 40 once again mating with the valleys 362. In this way, the cover is closed or opened. Preferably, the structures of the cover and the main body are adapted to control the degree of rotation of the hinge assembly, such that the positioning pin 40 can be held in one or more particular locations between the valleys 362 and the peaks 364.

In other embodiments, the positioning pin 40 can be melted in the pinholes 18 so that the positioning pin 40 is firmly engaged in the housing 10. The spring 20 can be replaced by another kind of elastic element or urging mechanism.

It is believed that the present invention and its advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

1. A hinge assembly for joining a cover to a main body of a foldable device, comprising:
a hollow housing comprising an open end, and a hole in an opposite second end, a peripheral wall of the housing defining a pair of opposite pinholes adjacent to the open end;
an urging mechanism received in the housing;
a shaft including a cam portion received in the housing and including a shaft portion extending out through the hole of the housing, one end of the cam portion having a cam surface; and
a positioning pin retained in the pinholes of the housing;
wherein the shaft portion passes through the urging mechanism, one end of the urging mechanism biases the cam portion, an opposite end of the urging mechanism biases the second end, and the positioning pin is rotatable relative to the shaft and movably engaged with the cam surface; and
when the second end is urged in an axial direction by the urging mechanism, the cam surface causes the positioning pin to rotate the housing.

2. The hinge assembly as claimed in claim 1, wherein the housing is generally cylindrical but with at least one planar sidewall, for fixing the housing in the cover.

3. The hinge assembly as claimed in claim 2, wherein the housing defines a cylindrical cavity.

4. The hinge assembly as claimed in claim 3, wherein the urging mechanism is a helical spring received in the cavity.

5. The hinge assembly as claimed in claim 4, wherein the cam portion is cylindrical, and a diameter of the cam portion is less than a diameter of the cavity.

6. The hinge assembly as claimed in claim 5, wherein the cam surface has a pair of opposite valleys and a pair of opposite peaks.

7. The hinge assembly as claimed in claim 1, wherein the shaft portion is a generally cylindrical body but with at least one planar side, for fixing the shaft portion in the main body.

8. The hinge assembly as claimed in claim 7, wherein the positioning pin is interferingly engaged in the pinholes of the housing.

9. A hinge assembly for rotatably joining a cover to a main body of a foldable device, comprising:
a hollow housing comprising an open end, and a hole in an opposite rear end, a pair of opposite pinholes being defined in a peripheral wall of the housing adjacent to the open end;
an elastic element received in the housing, a first end of the elastic element being coupled to the rear end of the housing;
a shaft including a cam portion received in the housing and a shaft portion extending out through the hole of the housing, one end of the cam portion having a cam surface; and
a positioning pin retained in the pinholes of the housing;
wherein the shaft portion passes through the elastic element, a second end of the elastic element is coupled to the cam portion, and the positioning pin is rotatable relative to the shaft and movably engaged with the cam surface; and
when the positioning pin is rotated by application of an external force, the housing is driven in an axial direction and compresses the elastic element.

10. The hinge assembly as claimed in claim 9, wherein the housing is generally cylindrical but with at least one planar sidewall, for fixing the housing in the cover.

11. The hinge assembly as claimed in claim 10, wherein the housing defines a cylindrical cavity.

12. The hinge assembly as claimed in claim 11, wherein the elastic element is a helical spring received in the cavity.

13. The hinge assembly as claimed in claim 12, wherein the cam portion is cylindrical, and a diameter of the cam portion is less than a diameter of the cavity.

14. The hinge assembly as claimed in claim 13, wherein the cam surface has a pair of opposite valleys and a pair of opposite peaks.

15. The hinge assembly as claimed in claim 9, wherein the shaft portion is a generally cylindrical body but with at least one planar side, for fixing of the shaft portion in the main body.

16. The hinge assembly as claimed in claim 15, wherein the positioning pin is interferingly engaged in the pinholes of the housing.

17. A hinge assembly for a portable electronic device, comprising:
a housing comprising a cavity communicating with outside of said housing from one side thereof, said housing attached to one part of said portable electronic device;
a shaft rotatably and partially received in said cavity of said housing and having a shaft portion extending out of said housing from said side of said housing so as to attach to another part of said portable electronic device, and allow said another part of said portable electronic device performing a relative rotation to said one part of said portable electronic device, a cam portion defined on said shaft in said housing;
a positioning member used to confine said shaft partially staying in said cavity, said positioning member partially engaging with said cam portion of said shaft, said shaft being movable along a extending direction of said shaft portion of said shaft in case of moving of said positioning member against said cam portion along a direction perpendicular to said extending direction; and
an elastic element received in the housing to maintain a pressured engagement between said positioning member and said cam portion of said shaft.

18. The hinge assembly as claimed in claim 17, wherein said cam portion further defines a cam surface facing said position member to allow said positioning member to engage therewith and move thereon.

19. The hinge assembly as claimed in claim 17, wherein said cam portion is larger than said shaft portion and constrained by said side of said housing from moving out of said housing through said side of said housing.
